(19) United States
(12) Patent Application Publication
(10) Pub. No.: US 2026/0289450 A1
(43) Pub. Date: Sep. 24, 2026

(54) CONSTRUCTION FORECASTING SYSTEM WITH DEPENDENCY STRUCTURES

(71) Applicant: Microsoft Technology Licensing, LLC, Redmond, WA (US)

(72) Inventors: Oisin Michael HUGHES, Coupeville, WA (US); Scott Vincent ROWE, Scottsdale, AZ (US); Ping LIANG, Bellevue, WA (US); Yuhong Qian, Sammamish, WA (US); Zhenhai ZHANG, Bellevue, WA (US); Anpu LI, Bellevue, WA (US); Chih-Ning LIANG, Kirkland, WA (US)

(21) Appl. No.: 19/085,634

(22) Filed: Mar. 20, 2025

(51) Int. Cl. G06Q 10/0631; G06N 7/01; G06Q 50/08

(52) U.S. Cl. CPC G06Q 10/06313; G06N 7/01; G06Q 10/06312; G06Q 10/06316; G06Q 50/08

(57) ABSTRACT

A computer implemented method includes receiving digital representations of timing of multiple construction project milestones of a construction project, each milestone of the project milestones having an expected completion date. Tranches are generated where each tranche includes a subset of the project milestones. Iterative random sampling is performed by hierarchical models that depend on each other and represent dependencies between the tranches to simulate a timing of the construction project tranche to propagate construction delays determined from the received digital representations from a tranche of the tranches to a dependent tranche of the tranches the dependencies including tranche dependencies and external dependencies. Delays from each model of the hierarchical models are accumulated to generate an expected completion date of the construction project.

### BACKGROUND

Modern data center construction projects are characterized by complex interdependencies between various internal subsystems (e.g., power distribution, cooling infrastructure, server deployment) and external infrastructure (e.g., network connectivity, utility services). Traditional project management tools often treat construction activities as isolated or sequential tasks, failing to account for the intricate and dynamic relationships between these components. This oversight leads to inaccurate project forecasts, inefficient resource allocation, and limited risk mitigation.

### SUMMARY

A computer implemented method includes receiving digital representations of timing of multiple construction project milestones of a construction project, each milestone of the project milestones having an expected completion date. Tranches are generated where each tranche includes a subset of the project milestones. Iterative random sampling is performed by hierarchical models that depend on each other and represent dependencies between the tranches to simulate a timing of the construction project tranche to propagate construction delays determined from the received digital representations from a tranche of the tranches to a dependent tranche of the tranches the dependencies including tranche dependencies and external dependencies. Delays from each model of the hierarchical models are accumulated to generate an expected completion date of the construction project.

### BRIEF DESCRIPTION OF THE DRAWINGS

FIG. 1 is a block diagram of a multilayer simulation system for forecasting construction completion dates according to an example embodiment.

FIG. 2 is a listing of descriptions of columns of information contained in a dependency data structure for model input according to an example embodiment.

FIG. 3 is a table illustrating a dependency data structure according to an example embodiment.

FIG. 4 is an example construction timeline 400 for a data center construction project according to an example embodiment.

FIG. 5 is a phase diagram illustrating phases of construction of a data center construction project according to an example embodiment.

FIG. 6 is a timeline illustrating multi-layer tranche dependencies in a data center construction project according to an example embodiment.

FIG. 7 is a flowchart illustrating a computer implemented method of executing a multilayer simulation system to forecast data center project construction completion dates according to an example embodiment.

FIG. 8 is a schematic representation of a multilayer simulation framework according to an example embodiment.

FIG. 9 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The increasing scale and complexity of data center projects demands a more sophisticated approach to timeline prediction and risk management. Existing methodologies do not adequately model cascading delays or dynamically adjust to real-time project developments, resulting in suboptimal decision-making and increased operational costs.

Humans used to use timelines and spreadsheets to keep track of construction delays in order to schedule work on different phases of construction. Such methods worked well for simple construction projects such as building dwellings. The construction of data centers effectively exploded the number of milestones to track and schedule and also introduced very complex dependencies. Monte Carlo simulations of construction scheduling provided some help in tracking construction schedules but involved multiple iterations of calculations that are not practically performable by humans. Events that contribute to scheduling perturbations occur on a daily basis, making it impossible for humans to manually track, even with the aid of pen and paper or spreadsheets, even if computer implemented. With the introduction of external dependencies, tracking scheduling becomes even more complex.

### ABBREVIATIONS

IFP stands for Design “Issue for Permitting” which refers to a stage that a design is complete and ready to request permitting.

MAE—Mean Absolute Error
CR—Colo (Room in data center) Ready
CC—Construction Cycle
AE—Architectuaral Engineering
DC—Data Center
GC—General Contractor
EW—Earth Work
LLE—Long Lead Equipment
FS—Foundation Start
IST—Integrated System Testing
RSP—Rack Stack Patch
IFC—Issued for Construction
NID—Network Infrastructure Deployments
NL—Network Live
POR—Plan of Record
SL—Security Lockdown
DCPS—Data Center Physical Security
CIA—Cloud Infrastructure & Acquisition (fiber related work)
RNI—Ready for Network Installation

A multilayer simulation system for forecasting construction schedules provides superior predictive accuracy and risk mitigation compared to traditional methods. By incorporating real-time data and modeling complex interdependencies, the system reduces uncertainty, enhances decision-making, and improves resource allocation efficiency. The system is scalable to adapt to construction projects of varying complexity and size. The system continuously integrates live data feeds and dynamically adjusts the simulation based on the progress of dependent components, enabling more accurate predictions and proactive risk identification.

A delay alarm may be generated in response to delays in schedule being identified by the system. Program management teams will investigate the root cause of the delay, identify the stage causing the delay (referred to as a stage of the blocker), and discuss solutions. Examples of delays may include a power constraint where electricity will not arrive on time. Network installation may then be prioritized to mitigate the delay and reduce the risk of a room or colo not being ready on time. A further example includes internal equipment delays. To mitigate this risk to the schedule, external connectivity devices may be expedited so work can be done more quickly when the delayed equipment arrives.

The system, in one example, provides construction forecasting by incorporating real time data from contractors into a dependency data structure. The system uses the dependency data structure in modeling a construction timeline. The incorporation of real time data into the dependency data structure enables faster identification of issues related to construction timeliness in order to more quickly address construction problems.

Construction components may be thought of as milestones, with each milestone having an expected completion date. The construction milestones in one example are divided into layers comprising infrastructure layer milestones, systems layer milestones, and operational layer milestones. Dependencies between the milestones may occur between the different layers. Tranches may be thought of as a set of milestones having dependencies. A tranche can include a part of the colo, or one or more colos. Different tranches within a project may have dependencies, such as tranche 2 needing to wait for tranche 1 to complete.

In one example related to building data centers, multiple rooms or colos may be built in succession. Each room in one example is designed to consume a set amount of power, such as 9.6 MW to provide computing and storage services. Each successive room may be dependent on a previous room being completed.

In one example, a project may include 6 buildings (a, b, c, d, e, f). In a 1^{st} phase, building a is completed. In a 2^{nd} phase, buildings b, c, and d are completed. And in a 3^{rd} phase, buildings e and f are completed. A building here can be thought of as a colo. A phase here can be thought of as a tranche.

It is also possible that a building is completed in two phases. Therefore, a colo could be related to 1+ tranches, and a tranche could be related to 1+ colos.

In further examples, the set of milestones comprising a tranche may be one milestone or several milestones. There is significant flexibility in selecting what constitutes a tranche, which enables one to fine tune the granularity of the simulation based on experience. Tranches may also be selected based on dependencies. In one example, a tranche may be formed of a milestone or set of milestones that need to be completed prior to another milestone being completed.

In one example, respective models of the hierarchical models represent different dependency layers. The layers may include an infrastructure layer, system layer, and operational layer, ensuring accurate propagation of delays or risks in construction of a data center. Interdependencies between constructions milestones are accounted for by the use of the hierarchical models along with a buffer to propagate delays into succeeding models.

Basically, a succeeding model in the hierarchy is dependent on the completion of a portion of the constructions project in one or more previous models. The first layer in the hierarchy of models does not have any dependencies. In the second layer, a network installation dependency may be added. Successive layers may include further dependencies.

In addition, a succeeding colo may have stages dependent on a previous colo's scheduling stages. In one example, when installing the network, a previous colo must be completed before the network can be provided to the succeeding colo, expressed as a dependency on RNI. The buffer accumulates delays for the entire project resulting in reduction of forecasting uncertainty, more accurate predictions, enhancing decision-making, proactive risk identification, and improving resource allocation efficiency.

In one example, the system leverages Monte Carlo simulations and probabilistic modeling to quantify risks and uncertainties at each project stage. The system also provides confidence intervals for timeline forecasts, enabling data-driven risk mitigation strategies. Monte Carlo simulations may also be used for the buffer component of the system.

The dependency data structure enables several technical improvements in performance of the system in dynamically determining completion dates in any kind of real estate construction project or projects. The dependency data structure enables dependency modeling by the system where dependencies are represented among construction components. One example of a dependency in the context of building a data center includes cooling systems that cannot be operational until power systems are complete. External dependencies, such as network readiness or utility availability that are needed before a data center room or Colo can be operational, are also accounted for in the simulations.

The dependency data structure also enables multi-level simulation by using hierarchical models to represent different dependency layers, ensuring accurate propagation of delays or risks. The system simulates the interplay between various levels (e.g., interdependence of infrastructure and construction components).

The system dynamically updates data center completion date estimates in real time in response to new data being added to the dependency data structure.

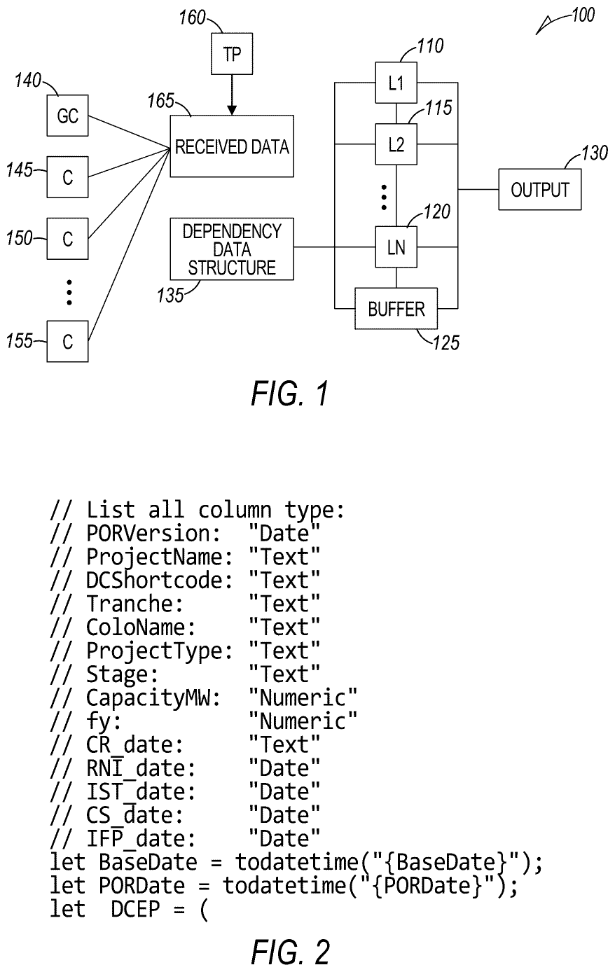

FIG. 1 is a block diagram of a multilayer simulation system 100 for forecasting construction completion dates. System 100 performs hierarchical simulation at multiple layers 110, 115, 120 corresponding to successive tranches, and includes a buffer 125 that accumulates delays corresponding to complex interdependencies between tranches to reflect unforeseen disruptions in the construction process. Output 130 provides a completion time value that is a function of the buffer accumulated delays and layer simulations.

A dependency data structure 135 contains information related to tranches. The information identifies projects, colos, start and completion dates, and other information described in greater detail with respect to FIG. 2. In one example, data related to the tranches is provided by at least a general contractor (GC) 140 and one or more subcontractors 145, 150, 155. Third parties, such as utility companies, may also provide data at 160. The data may be provided in a P6 format which is commonly used for data exchange in construction projects and is received at received data 165.

Construction P6 data includes schedules, progress data, and time tracking information. Primavera or P6 data can be received as an XER, XML, PDF or even an XLS project file.

The received data 165 is modified to populate the dependency data structure 135. In one example, the P6 data is received as an XER file. A pipeline parses the data and formats it as a table where each row of record represents all information of a specific colo.

FIG. 2 is a schema or listing 200 of descriptions of columns of information contained in dependency data structure 135. The descriptions include a POR Version date, DCShortCode, Tranche, ColoName, ProjectType, Stage, CapacityMW, fy, CR_date, RNI_date, IST_Date, CS_date, and IFP_Date. A BaseDate, PORDate, and DCEP date may be calculated and included.

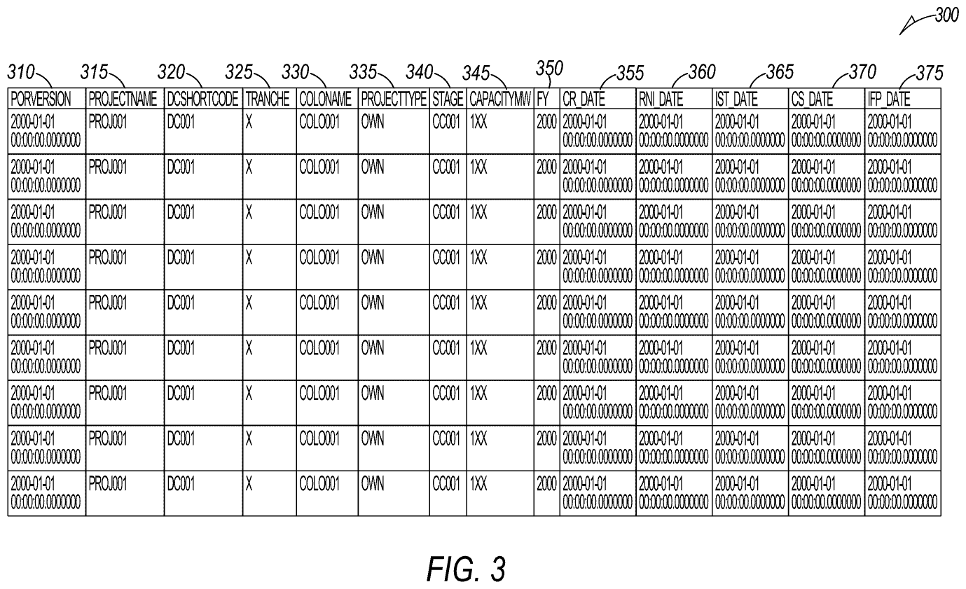

FIG. 3 is a table illustrating a dependency data structure 300 for use by the simulation system 100 in forecasting construction completion date. Data structure 300 is shown in table form for ease of representation and includes columns comprising POR Version 310, ProjectName 315, DCShortCode 320, Tranche 325, ColoName 330, ProjectType 335, Stage 340, CapacityMW 345, fy 350, CR_Date 355, RNI_date 360, IST_date 365, CS_date 370, and IFT_date 375.

Due to the complex dependencies and tranche, colo and project′ levels, one tranche can have several colos, in this case, multiple rows have a same tranche value. In a further example, one tranche may only match one colo. In such an example, each row covers a different tranche.

An example of rows with corresponding tranches and colos for a project include:

Proj 1 Tranche A Colo 1
Proj 1 Tranche B Colo 2
Proj 1 Tranche B Colo 3
Proj 1 Tranche C Colo 4
Proj 1 Tranche D Colo 4

In one example, hierarchical dependencies for a cooling system would at least include that the cooling system cannot be operational until a power system is operational. In other words, the cooling system is dependent on an operational power system. In turn, the power system would be dependent on a power utility contract and connection to a power grid or even backup generators being installed.

Thirty to fifty permits and other permissions are currently needed to proceed with different stages of data center construction. A permit is needed to actually start construction, then to put in a generator, and even a final operational permit is required. A fire marshal permission is also needed before actually starting up each colo.

The construction start permitting is a major variable that, in some cases, can require completion prior to applying for permits for earthwork and then foundation start. Such a sequential, as opposed to parallel, permitting can result in significant delays in starting construction, leading to pushing out expected completion dates.

One can start to see the complexities involved in construction of data centers and how encoding such dependencies in data structure 300 provides an efficient data source for use by system 100 in forecasting construction completion dates.

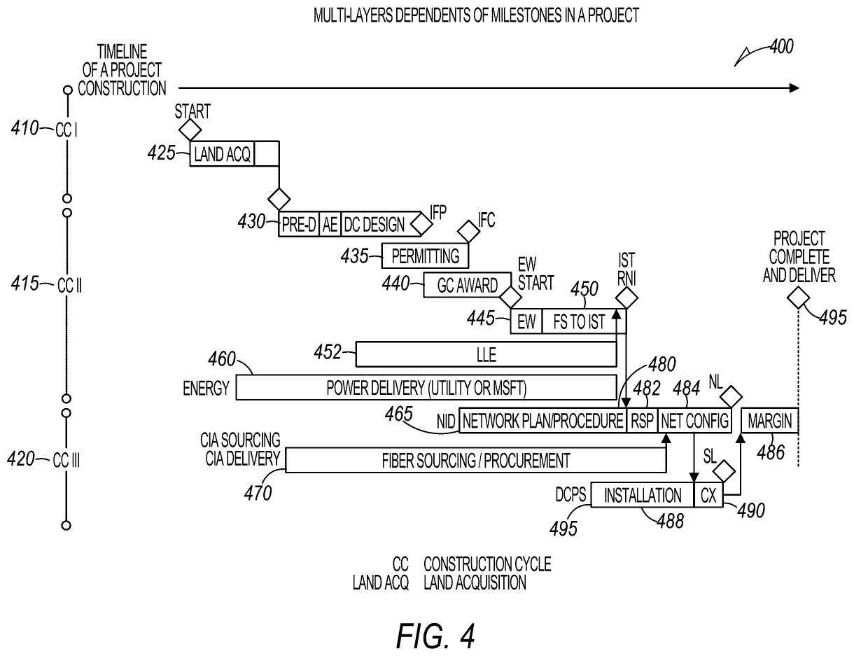

FIG. 4 is an example construction timeline 400 for a data center construction project for use as a representative example. Multiple layers of dependencies exist, such as those related to energy, fiber, network connectivity, permitting, and other components across different construction phases. The dependencies apply to all colos in a project. System 100 utilizes the dependency data structure, that identifies the most critical path (i.e., each schedule phase) within each construction cycle, to minimize the risk of delays for each phase to ensure the completion and delivery of the project on time.

Three construction cycles are illustrated, CC I 410, CC II 415, and CC III 420 along with multiple milestones of the construction project. Milestones include for example, land acquisition 425. Land acquisition 425 is in CC I 410 and is the overall start of the construction project. Land must be acquired prior to other planning. Once acquired, CC II 415 begins with planning 430 that includes pre-D, AE, and DC design. Permitting 435 can be initiated part way through planning 430. A general contractor can then be found and awarded at 440.

Once the general contractor is awarded, EW 445 and FS to IST 450 may begin, as they are dependent on the general contractor being awarded. CC II may also include LLE 452, which may start during planning 430, and energy 460, which may begin even prior to land acquisition 425 being completed. Energy 460 includes power delivery, such a power utility negotiations to obtain energy to run the data center, or even self-generation energy, and is closely tied to land acquisition 425 as proximity to energy generation can be a key consideration in energy availability and cost of operating the data center. Both LLE 455 and energy 460 are shown completing during FS to IST 450.

CC III includes a network installation team referred to as NID 465, a fiber installation team referred to as CIA sourcing and delivery 470, and data center physical security team (DCPS) installation 475. NID 465 includes network planning and procuring 480, RSP 482, network configuration 484, and margin 486. CIA sourcing and delivery 470 involves fiber sourcing and procurement, and DCPS includes installation 488 and Cx 490. One intercycle dependency is that FS to IST 450 must complete prior to RSP 482 beginning. Network configuration can only occur following CIA sourcing and delivery 470. Cx 490 must complete prior to network configuration 484 being completed. Product completion and delivery is represented at 495, following margin 486.

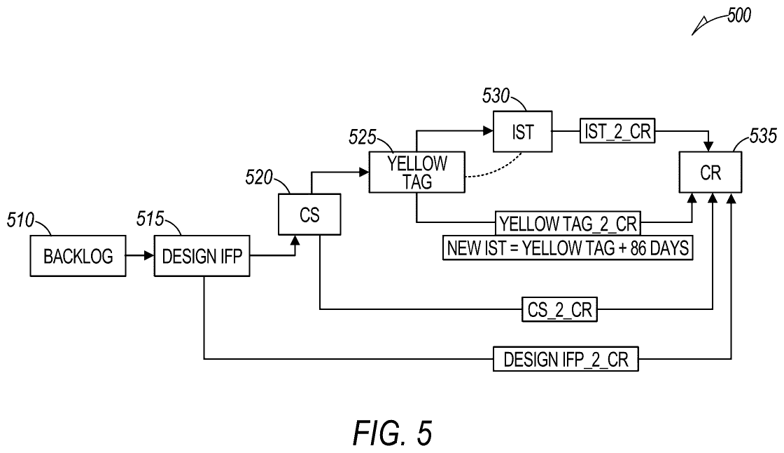

FIG. 5 is a phase diagram illustrating phases 500 of construction of data center construction project. The construction of a colo may be initiated based on backlog 510 indicative of a need for a further room. After the need is identified, design IFP 515 is begun to set in progress the phases of construction. The phases include CS 520, Yellow Tag 525, and IST 530 which lead to CR 535, meaning that the room or colo is ready.

CS 520 represents a construction has started phase, but the room is not ready. Yellow Tag 525 occurs next and includes equipment installation in the room, but the room is still not ready. IST 530 includes integration system testing to ensure that the equipment is operating correctly. Upon completion of IST 530, the room is ready at CR 535.

The phases 500 are for one room or colo of the data center being constructed. Data centers typically include multiple rooms and involve multiple different construction teams. The different construction teams are scheduled to work on different rooms at different times, as there may not be sufficient space in one room for each of the teams to work at the same time in addition to the different dependencies that must be accounted for prior to a teach beginning work in a room.

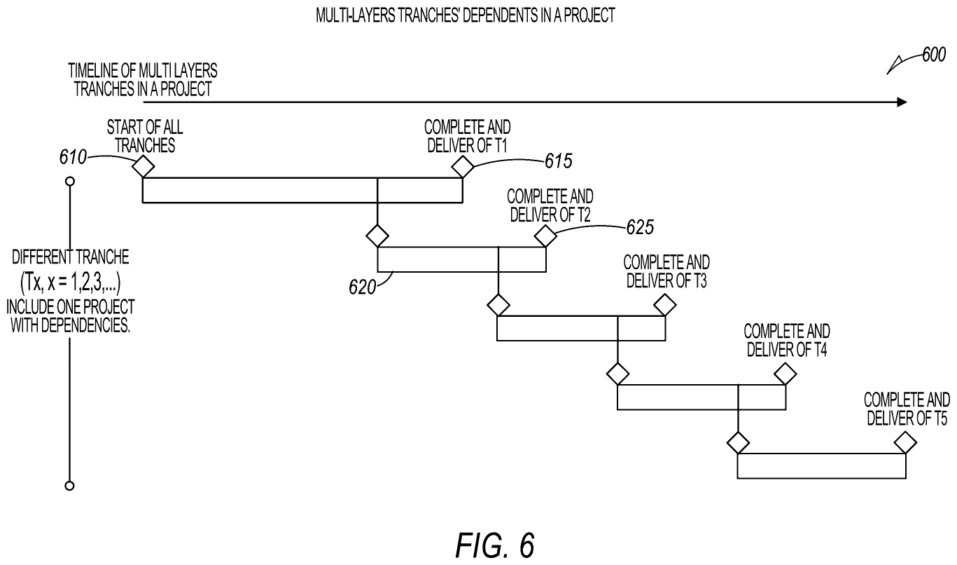

FIG. 6 is a timeline illustrating multi-layer tranche dependencies in a data center construction project generally at 600. In one example, each tranche corresponds to a different room or colo in the project, where successive rooms are completed in a planned order. Construction of tranches is started at 610. A first tranche, T1 is completed at 615. Prior to completion of the first tranche T1, work is also started on a second tranche T2 at 620, which is completed at 625, after completion of T1. Tranches T3, T4, and T5 proceed in a manner similar to T1, starting prior to completion of a previous tranche, and completing after completion of the previous tranche.

System 100 utilizes the dependency data structure 135 to simulate an expected single tranche completion date. Using multiple layers of simulation for successive tranches incorporates dependencies between tranches.

The simulation for each tranche determines a tranche completion data value [symbol] of a random variable X through iterative sampling. The random variable, X, represents a duration of a specific tranche, which can be affected by many different factors, such as weather delays or labor availability. In one example, a probability distribution associated with the tranche may be used to select random duration values to simulate different possible outcomes during the simulation. Historical completion time data may be generated using various probability distribution functions. A statistical distribution is selected that most closely matches the actual data by employing mathematical methods to compare the distribution distances. Basically, an average is calculated for a tranche via a layered modeling approach.

$$\text{?} \approx \frac{1}{N} {\sum }_{i = 1}^{N} f ( {X}_{i} ) + Duration ( {TPS}_{n} , TP {C}_{n} ) ,$$

Where:
[symbol] is the expected value of project complete date.
Xᵢ is the duration of each schedule phase to project complete date in the past identified by start and stop dates.
N is the total number of the random samples. N may be on the order of 100,000 and n may be between 1-10.
f(Xᵢ) is the output of the model for the i=th sample Xᵢ (the random data points input).
TPSₙ is the third party start date at tranche n.
TPCₙ is the third party complete date at tranche n.
Duration (TPSₙ,TPCₙ): Third-part company contributions are treated as special case, as the purchaser of the construction project cannot control the construction phase during whole construction cycles.

Based on the dependencies within multiple-layer tranches of a project, each project in a pipeline can have the tranche 1 outcomes directly forecasted using the above simulation method.

For subsequent tranches, depending on the specific characteristics of each construction phase, the critical components are identified, and the following formula can be utilized to calculate the completion dates of subsequent tranches, based on the completion dates of their preceding tranches. Note that a buffer is now included as the multiple layered tranche simulations are combined to arrive at a projected project completion date.

$$\text{?} = max ( \text{?} , {RNI}_{n} ) + \text{?} ( n \geq 2 )$$

Where:
[symbol] is the expected value of subsequent tranches' project complete date.
RNIₙ, as example, shows the critical components in Data Center construction cycle.
[symbol] is the expected value of previous tranche's project complete date.
B [symbol] rₙ is another forecast model from above simulated method.

$$\text{?} \approx \frac{1}{N} {\sum }_{i = 1}^{N} f ( {X}_{i} )$$

Where:

$$f ( {X}_{i} ) = {Y}_{T n} - max ( {Y}_{Tn - 1} , {RNI}_{n} ) for all completed projects$$

The buffer 125 provides a very helpful component in managing the uncertainties inherent in complex data center construction projects. Given the intricate interdependencies between infrastructure, systems, and operational layers, even minor delays in one phase can trigger cascading effects throughout the project. The buffer absorbs unforeseen disruptions and provides flexibility to mitigate risks without compromising the overall timeline.

The buffer 125 calculation is grounded in probabilistic modeling and simulations to accurately reflect real-world project variability. This data-driven approach produces a statistically valid measure that accounts for both delays in prior phases and critical project dependencies. The deliberate comparison between a tranche's completion and the RNI phase is a strategic choice. The RNI phase encapsulates vital internal and external dependencies—such as network readiness, utility provisioning, and other infrastructure components—that have a direct impact on project progression.

Delays in these critical dependencies can impede downstream tasks, regardless of progress in other areas. By dynamically incorporating variations in task durations and dependency outcomes, the buffer ensures that the bottlenecks are identified and addressed. This methodology effectively prioritizes the critical path and enhances the model's predictive accuracy. The buffer absorbs unexpected delays, preventing minor disruptions from escalating into significant project setbacks. Comparing to the RNI phase ensures the buffer targets the most impactful dependencies, reinforcing and protecting the critical path. The buffer continuously adjusts based on real-time data, dynamically adapting to allow proactive risk management and better decision-making throughout the project

Overall, system 100 includes an input layer that accepts data on resource allocation, dependencies, and progress metrics. A simulation layer runs multi-level simulations, combining Monte Carlo techniques with dependency graphs to model outcomes. An output layer provides timeline predictions, highlighting bottlenecks and critical paths in a layered format.

Historical Benchmarking compares simulation predictions against historical data from completed data center projects. System 100 can simulate all different kinds of building construction projects with dependencies. For data centers, server deployment relies on cooling systems, which in turn depend on power systems. External dependencies include that the network cannot be operational until regional fiber installation is complete. The simulation provided by system 100 predicts delays if the power system lags and adjusts downstream timelines accordingly.

Existing project forecasting methods often neglect complex interdependencies and real-time data. System 100 address that gap by introducing a multi-layer simulation framework that dynamically adjusts for these factors, providing more accurate and adaptive timeline predictions.

The simulation operates in three stages. Identification of Critical Parameters includes identifying key project parameters, focusing on critical phases that drive the project timeline and dependencies. Correlation Analysis and Buffer Calculation: The system utilizes a buffer estimation approach to analyze dependencies between project tranches and the overall project, dynamically adjusting buffer allocations based on local and global dependencies. System 100 provides simulation and forecasting. The simulation forecasts project completion, dynamically adjusting to real-time data on progress, delays, and dependencies.

The system predicts by dynamically adjusting buffers, addressing cascading delays, and optimizing resources. It leverages a scientific method for better decision-making, reducing uncertainty and improving risk management throughout the project lifecycle. Historical data and current project data appear to validate the system prediction, maintaining high accuracy scores.

The system combines multi-layer dependency modeling with real-time data integration, filling a critical gap in forecasting. Its focus on dynamically allocating buffers based on dependencies distinguishes it from existing methods, integrating complexity science with construction management for more effective project forecasting and risk management.

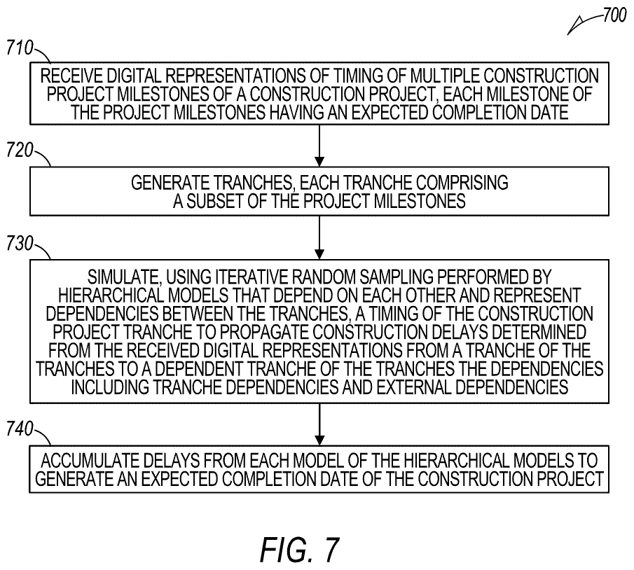

FIG. 7 is a flowchart illustrating a computer implemented method 700 of executing a multilayer simulation system to forecast data center project construction completion dates. Method 700 begins at operation 710 by receiving digital representations of timing of multiple construction project milestones of a construction project, each milestone of the project milestones having an expected completion date. The digital representations of timing include start and end dates.

Operation 720 generates tranches, with each tranche comprising a subset of the project milestones. The milestones may be divided into multiple layers comprising an infrastructure layer, a system layer, and an operational layer. Infrastructure layer milestones include foundation, structural integrity, and utility provisioning. System layer milestones include power systems, cooling mechanisms, and environmental controls. Operational layer milestones include server installation, network integration, and testing.

Operation 730 simulates, using iterative random sampling performed by hierarchical models that depend on each other and represent dependencies between the tranches, a timing of the construction project tranche to propagate construction delays determined from the received digital representations from a tranche of the tranches to a dependent tranche of the tranches the dependencies including tranche dependencies and external dependencies. generating a timing of each external dependency uses probabilistic modeling.

Delays are accumulated at operation 740 from each model of the hierarchical models to generate an expected completion date of the construction project. The simulating operation 730 and accumulating operation 740 are performed in response to receiving updates of the digital representations of the multiple construction milestones. Simulating a timing of the construction project utilizes a Monte Carlo simulation for each tranche and probabilistic modeling for each external dependency.

Received digital representations of timing of multiple construction project milestones are modified and stored in a table where each row of represents all information of a specific colo of the construction project that is accessible for simulating the timing of the construction project.

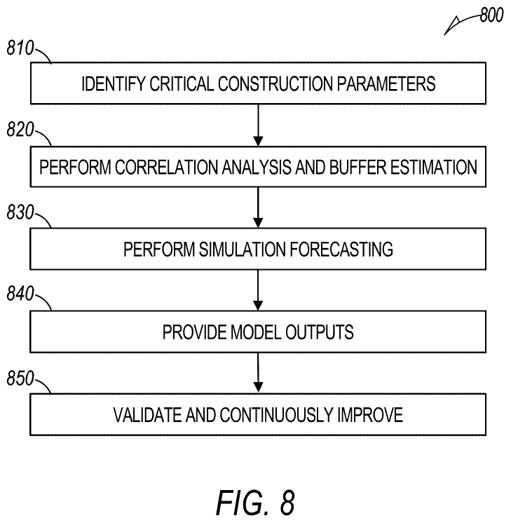

FIG. 8 is a schematic representation of a multi-layer simulation framework 800. Simulation framework 800 includes an identification of critical construction project parameters at 810. Critical parameters influencing project timelines are systematically identified. Dependencies among phases are comprehensively analyzed to inform subsequent stages. Correlation analysis and buffer estimation is performed at 820 where a detailed analysis of project tranche dependencies is conducted, evaluating both local and global impacts. Buffer allocations are dynamically adjusted to address identified dependencies.

Simulation and forecasting is performed at 830 where simulation integrates real-time data on project status, including delays and progress, allowing dynamic recalculation of buffers for enhanced forecasting accuracy. Model outputs are provided at 840 where the model provides accurate, adaptive timelines and actionable insights for resource allocation and effective project management. At 850, validation and continuous Improvement is performed. Ongoing validation with historical and real-time data ensures continuous refinement and improved accuracy of the forecasting model.

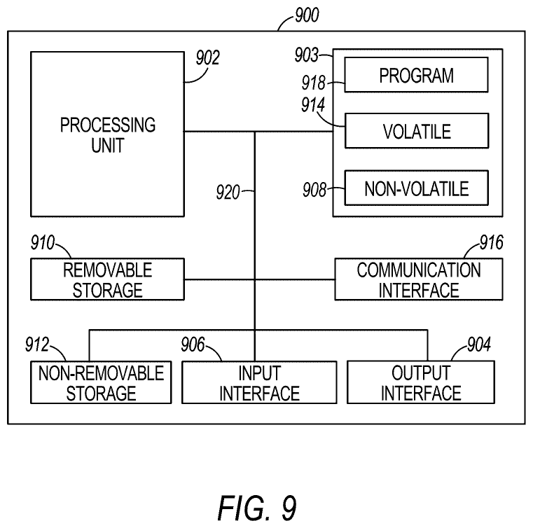

FIG. 9 is a block schematic diagram of a computer system 900 to receive, modify, and store construction scheduling information from distributed sources, perform simulations to generate status and completion estimates, and for performing methods and algorithms according to example embodiments. All components need not be used in various embodiments.

One example computing device in the form of a computer 900 may include a processing unit 902, memory 903, removable storage 910, and non-removable storage 912. Although the example computing device is illustrated and described as computer 900, the computing device may be in different forms in different embodiments. For example, the computing device may instead be a smartphone, a tablet, smartwatch, smart storage device (SSD), or other computing device including the same or similar elements as illustrated and described with regard to FIG. 9. Devices, such as smartphones, tablets, and smartwatches, are generally collectively referred to as mobile devices or user equipment.

Although the various data storage elements are illustrated as part of the computer 900, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 918 may be used to cause processing unit 902 to perform one or more methods or algorithms described herein.

### EXAMPLES

1. A computer implemented method includes receiving digital representations of timing of multiple construction project milestones of a construction project, each milestone of the project milestones having an expected completion date. Tranches are generated where each tranche includes a subset of the project milestones. Iterative random sampling is performed by hierarchical models that depend on each other and represent dependencies between the tranches to simulate a timing of the construction project tranche to propagate construction delays determined from the received digital representations from a tranche of the tranches to a dependent tranche of the tranches the dependencies including tranche dependencies and external dependencies. Delays from each model of the hierarchical models are accumulated to generate an expected completion date of the construction project.

2. The method of example 1 wherein simulating and accumulating are performed in response to receiving updates of the digital representations of the multiple construction milestones.

3. The method of any of examples 1-2 wherein the digital representations of timing include start and end dates.

4. The method of any of examples 1-3 wherein the milestones are divided into multiple layers comprising an infrastructure layer, a system layer, and an operational layer.

5. The method of example 4 wherein infrastructure layer milestones include foundation, structural integrity, and utility provisioning.

6. The method of any of examples 4-5 wherein system layer milestones include power systems, cooling mechanisms, and environmental controls.

7. The method of any of examples 4-6 wherein operational layer milestones include server installation, network integration, and testing.

8. The method of any of examples 1-7 wherein generating a timing of each external dependency uses probabilistic modeling.

9. The method of any of examples 1-8 wherein simulating a timing of the construction project utilizes a Monte Carlo simulation for each tranche and probabilistic modeling for each external dependency.

10. The method of any of examples 1-9 wherein received digital representations of timing of multiple construction project milestones are modified and stored in a table where each row of represents all information of a specific colo of the construction project that is accessible for simulating the timing of the construction project.

11. A machine-readable storage device has instructions for execution by a processor of a machine to cause the processor to perform operations to perform any of the methods of examples 1-20.

12. A device includes a processor and a memory device coupled to the processor and having a program stored thereon for execution by the processor to perform operations to perform any of the methods of examples 1-20.

13. A computer implemented method includes receiving digital representations of timing of multiple construction project milestones, each milestone having an expected completion date, dividing the digital representation of the multiple construction milestones into layers comprising infrastructure layer milestones, systems layer milestones, and operational layer milestones, digitally representing dependencies between the components in the different layers, generating tranches, each tranche comprising a set of milestones having dependencies, digitally representing timing of external dependencies of the construction project, simulating a timing of the construction project using hierarchical models trancheby trancheto represent dependencies between the layers to propagate construction delays determined from the received digital representations and dependencies between layers using iterative random sampling, generating a timing of each external dependency, and appending the timing of each of the external dependencies with the simulated timing to generate an expected project completion date.

22. A computer implemented method includes receiving digital representations of timing of multiple construction project milestones, each milestone having an expected completion date, generating traunches, each traunch comprising a set of milestones, simulating a timing of the construction project using hierarchical models traunch by traunch to represent dependencies, including external dependencies, to propagate construction delays determined from the received digital representations using iterative random sampling, generating a buffer value that accounts for both delays in prior construction phases and milestone dependencies, and accumulating delays from each of the hierarchical models and the buffer value to generate an expected completion date of the projection.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated from the described flows, and other components may be added to, or removed from, the described systems. Other embodiments may be within the scope of the following claims.

1. A computer implemented method, the method comprising:
receiving digital representations of timing of multiple construction project milestones of a construction project, each milestone of the project milestones having an expected completion date;
generating tranches, each tranche comprising a subset of the project milestones;
simulating, using iterative random sampling performed by hierarchical models that depend on each other and represent dependencies between the tranches, a timing of the construction project tranche to propagate construction delays determined from the received digital representations from a tranche of the tranches to a dependent tranche of the tranches the dependencies including tranche dependencies and external dependencies; and
accumulating delays from each model of the hierarchical models to generate an expected completion date of the construction project.

2. The method of claim 1 wherein simulating and accumulating are performed in response to receiving updates of the digital representations of the multiple construction milestones.

3. The method of claim 1 wherein the digital representations of timing include start and end dates.

4. The method of claim 1 wherein the milestones are divided into multiple layers comprising an infrastructure layer, a system layer, and an operational layer.

5. The method of claim 4 wherein infrastructure layer milestones include foundation, structural integrity, and utility provisioning.

6. The method of claim 4 wherein system layer milestones include power systems, cooling mechanisms, and environmental controls.

7. The method of claim 4 wherein operational layer milestones include server installation, network integration, and testing.

8. The method of claim 1 wherein generating a timing of each external dependency uses probabilistic modeling.

9. The method of claim 1 wherein simulating a timing of the construction project utilizes a Monte Carlo simulation for each tranche and probabilistic modeling for each external dependency.

10. The method of claim 1 wherein received digital representations of timing of multiple construction project milestones are modified and stored in a table where each row of represents all information of a specific colo of the construction project that is accessible for simulating the timing of the construction project.

11. A machine-readable storage device having instructions for execution by a processor of a machine to cause the processor to perform operations to perform a method, the operations comprising:
receiving digital representations of timing of multiple construction project milestones of a construction project, each milestone of the project milestones having an expected completion date;
generating tranches, each tranche comprising a subset of the project milestones;
simulating, using iterative random sampling performed by hierarchical models that depend on each other and represent dependencies between the tranches, a timing of the construction project tranche to propagate construction delays determined from the received digital representations from a tranche of the tranches to a dependent tranche of the tranches the dependencies including tranche dependencies and external dependencies; and
accumulating delays from each model of the hierarchical models to generate an expected completion date of the construction project.

12. The device of claim 11 wherein simulating and accumulating are performed in response to receiving updates of the digital representations of the multiple construction milestones wherein the digital representations of timing include start and end dates.

13. The device of claim 11 wherein the milestones are divided into multiple layers comprising an infrastructure layer, a system layer, and an operational layer.

14. The device of claim 13 wherein infrastructure layer milestones include foundation, structural integrity, and utility provisioning, wherein system layer milestones include power systems, cooling mechanisms, and environmental controls, and wherein operational layer milestones include server installation, network integration, and testing.

15. The device of claim 11 wherein generating a timing of each external dependency uses probabilistic modeling and wherein simulating a timing of the construction project utilizes a Monte Carlo simulation for each tranche and probabilistic modeling for each external dependency.

16. The device of claim 11 wherein received digital representations of timing of multiple construction project milestones are modified and stored in a table where each row of represents all information of a specific colo of the construction project that is accessible for simulating the timing of the construction project.

17. A device comprising:
a processor; and
a memory device coupled to the processor and having a program stored thereon for execution by the processor to perform operations comprising:
receiving digital representations of timing of multiple construction project milestones of a construction project, each milestone of the project milestones having an expected completion date;
generating tranches, each tranche comprising a subset of the project milestones;
simulating, using iterative random sampling performed by hierarchical models that depend on each other and represent dependencies between the tranches, a timing of the construction project tranche to propagate construction delays determined from the received digital representations from a tranche of the tranches to a dependent tranche of the tranches the dependencies including tranche dependencies and external dependencies; and
accumulating delays from each model of the hierarchical models to generate an expected completion date of the construction project.

18. The device of claim 17 wherein simulating and accumulating are performed in response to receiving updates of the digital representations of the multiple construction milestones wherein the digital representations of timing include start and end dates.

19. The device of claim 11 wherein the milestones are divided into multiple layers comprising an infrastructure layer, a system layer, and an operational layer, wherein infrastructure layer milestones include foundation, structural integrity, and utility provisioning, wherein system layer milestones include power systems, cooling mechanisms, and environmental controls, and wherein operational layer milestones include server installation, network integration, and testing.

20. The device of claim 17 wherein generating a timing of each external dependency uses probabilistic modeling and wherein simulating a timing of the construction project utilizes a Monte Carlo simulation for each tranche and probabilistic modeling for each external dependency and wherein received digital representations of timing of multiple construction project milestones are modified and stored in a table where each row of represents all information of a specific colo of the construction project that is accessible for simulating the timing of the construction project.
